(19) United States
(12) Patent Application Publication
(10) Pub. No.: US 2010/0170534 A1
(43) Pub. Date: Jul. 8, 2010

(54) METHOD FOR REMOVAL OF SURFACE CONTAMINANTS FROM SUBSTRATES

(76) Inventors: Loren L. Hatle, Humble, TX (US); Jeffrey Longmore, Nassau Bay, TX (US)

Correspondence Address: DUNLAP CODDING, P.C., PO BOX 16370, OKLAHOMA CITY, OK, 73113, US

(21) Appl. No.: 12/689,945

(22) Filed: Jan. 19, 2010

Related U.S. Application Data
(63) Continuation of application No. 11/511,919, filed on Aug. 28, 2006, now abandoned.
(60) Provisional application No. 60/711,353, filed on Aug. 26, 2005.

(51) Int. Cl. B08B 1/00; B08B 3/08

(52) U.S. Cl. 134/6; 134/29; 134/28

(57) ABSTRACT

A method is disclosed for preparing a substrate for coating. The method uses a step of applying an acidic solution to the substrate to break down visible and non-visible layers of surface material. The method also uses a step of applying a treatment solution to decontaminate the substrate. The method further comprises a step of applying an aqueous rinsing solution to the substrate to remove neutralized ionic contaminants for the substrate.

### CROSS REFERENCE TO RELATED APPLICATIONS

This application is a continuation of U.S. Ser. No. 11/511,919, filed on Aug. 28, 2006, which claims priority to the provisional patent application identified by U.S. Ser. No. 60/711,353, filed on Aug. 26, 2005, the entire contents of each being hereby incorporated by reference.

### BACKGROUND OF THE INVENTION

It is common in several industries to apply coatings to substrates for a variety of purposes. For example, metallic and other substrates can be contacted with a protective layer that reduces wear on the use.

No matter the form or makeup of the substrate, it is highly desirable that the substrate be effectively cleaned prior to application of the coating. If the substrate is not prepared properly prior to application of the coating, the effective life of the coating can be adversely affected. Ultimately, the substrate may need to be recleaned and recoated, which can introduce additional cost for the maintenance of the apparatus having the substrate and typically requires that the apparatus be taken offline during these processes.

Various coatings are applied to metallic substrates. It is highly desirable that the metallic substrate be effectively cleaned of ionic contaminants prior to the application of the coating so that the useful coating life may be prolonged. These contaminants can lead to aggressive corrosion of the underlying substrate.

A key accelerant of aggressive corrosion is the result of microbiological, water and non-water soluble surface ionic contaminants, either because they directly attack substrates or cause premature coatings failure. Microbial Influenced Corrosion (MIC) is caused by bacteria, such as sulfate reducing bacteria, acid producing bacteria, and other contaminants and is the principal cause of coating failure. Bacteria settle next to the substrate and produce acids and other ionic compounds that corrode the steel and cannot be removed using standard methods alone. Unless these contaminants are effectively removed, surface coatings trap contaminants between the coating and substrate. As moisture and other compounds begin to permeate the coating film, these particles stimulate the formation of corrosion cells caused by these microbial byproduct contaminants, water soluble and non-water soluble ionic contaminants and start the corrosion process. As the surface corrodes, moisture vapor begins to build pressure between the coating and the substrate. Ultimately, this can result in premature failure of the coating.

As an example, media blasted steel substrates are susceptible to corrosion and coating failure due to moisture-based chloride. Ferrous chloride is formed whenever steel or iron and soluble chloride in moisture are in contact. This reaction, in itself, is a strong corrosive of steel surfaces. Upon exposure to air, ferrous chloride oxidizes to ferric chloride, a hygroscopic salt with a natural affinity for moisture in the air. Trace amounts of either ferric or ferrous chloride remaining on the substrate accumulate moisture from the air resulting in the formation of a concentrated iron chloride solution on the surface of the steel substrate. Iron ions, chloride ions and water comprise an electrolytic solution that drives an electrochemical corrosion reaction. Coatings applied over such a substrate fail in a short period of time due to the concentrated iron chloride solution on the substrate drawing water through the coating by osmosis and creating a blistering or disbondment of the coating. Rates of coating failure due to osmotic blistering are dependent on the thickness and porosity of the coating.

Contamination of substrates from soluble salts has been identified as a source of coating failure and has been thoroughly documented. Practical, cost effective solutions to the problem have eluded routineers in the coating science field. Complicating the search for cost-effective solutions is the lack of standards defining acceptable levels of soluble salt contaminations or concentrations on substrates. The level of cleanliness required varies significantly with the service environment and the characteristics of the coating selected. However, independent of these variables, it has been proven that the cleaner the substrate, the greater the resistance to coating disbondment.

Various coatings are also applied to concrete substrates. Concrete is of course different from metallics such as steel in that it is not chemically reactive with water soluble salts such as sodium chloride.

Concrete is a cast material that is porous by nature. The porosity of concrete may provide water and air pockets extending from the surface into the material to a depth of one inch or more. The amount of porosity varies with the method of casting of the cement and the type of finish applied. Hard troweling of the surface minimizes porosity.

The coating performance of concrete substrates is affected primarily by two problems. One problem involves the formation of a thin layer of non-reactive materials on the surface of cured new concrete as a residue. The residue forms a weak powdering material with little adhesive strength and therefore is not acceptable for the subsequent application of a coating material over the surface of the concrete. The other problem is that uncleaned concrete of any age contains water soluble salts in the voids. These salts create the same hygroscopic condition created by salt contaminants in steel because a microscopic layer of water is always present on the substrate regardless of temperature and humidity conditions, due to the hygroscopic nature of the salt contaminants. Coatings applied over salt contaminated surfaces fail in a short period of time due to poor adhesion caused by osmotic blistering.

Also, particularly when horizontal concrete surfaces are etched with acid, such as hydrochloric or muriatic acid, the reaction of the acid with the cement creates soluble salts which are present in the pores of the concrete. The removal of such soluble salts heretofore has been attempted by the use of a stiff bristle broom and copious amounts of rinse water which in many instances have been ineffective.

Standard responses to corrosion and the costs associated with corrosion are pervasive and highly standardized. Typical corrosion prevention measures include the use of various surface blasting processes and anti-corrosion materials. However, these measures fail to address molecular causes of corrosion. The approaches only delay the inevitable damage to serviceability or destruction of assets. For example, under normal circumstances metallic material in contact with corrosive materials must be remediated and recoated with a protective coating on average every five years. This represents a significant, ongoing cost that only slows the negative impacts of corrosion.

The standard anti-corrosion process follows a series of industry-defined stages. The process typically begins with careful cleaning of surfaces to a visual standard, such as those specified by the National Association of Corrosion Engineers (NACE) or The Society for Protective Coatings (SSPC). These standards of cleanliness, referred to as blasts, result in a surface that when viewed without magnification appears to be free of all visible oil, grease, dust, dirt, mill scale, rust, coating, oxides, corrosion products and other foreign matter.

The process consists of blasting an abrasive to achieve a specified standard of visual cleanliness (e.g., NACE 1, NACE 2) according to the requirements of the project and the specifications of the coating to be applied. Typically the blasting abrasive will consist of silica sand or equivalent material that is dry, neutral pH, and free of dust, clay or other foreign materials.

After the blasting stage, it is usually necessary to control the environment of the surface to allow for application of the coating. This can become a cost intensive process requiring industrial desiccant dryers and additional days of downtime. Alternatively, the environment may need to be cooled, which reduces humidity. Dehumidification (DH) is costly and time consuming.

Once the surfaces are visually clean, and existing environmental factors meet the specifications provided by the coatings manufacturer, an anti-corrosion coating may be applied.

Another method for the removal of surface contaminants from metallic and concrete substrates comprises the use of blasting an abrasive material in a pressurized water stream against the metallic and concrete surfaces for cleaning the surface. This blasting would then be followed up by rinsing the surface. A problem with this method is that the equipment used to provide the pressurized water stream is very specialized, expensive to purchase, and expensive to transport and store. Another problem is that using the abrasive material in the pressurized water stream can leave uncleaned areas that were not directly contacted with the pressurized stream. Having to directly cover the entire surface with the pressurized stream would cause the process to take a very long time, thus making it very inefficient.

### SUMMARY OF EXEMPLARY EMBODIMENTS

The invention provides methods for preparing a substrate for coating. An exemplary method according to the invention comprises the steps of applying an acidic solution to a substrate to break down visible and non-visible layers of surface material; applying a treatment solution to the substrate to decontaminate the substrate; and applying an aqueous rinsing solution to the substrate to remove neutralized ionic contaminants from the substrate; wherein the substrate comprises metallic surfaces, such as oilfield equipment.

An additional exemplary method comprises applying an acidic solution comprising a first aqueous solution including a citric acid and a gelling agent; applying a treatment solution comprising a second aqueous solution including a carbonate; and applying an aqueous rinsing solution until the pH of the substrate is about 7.

Another exemplary method comprises applying a rinsing solution comprising water having a conductivity less than about 10 micromhos to said substrate; applying an acidic solution to said substrate wherein the acidic solution comprises anhydrous citric acid, methyl cellulose, and water with a conductivity less than about 10 micromhos; allowing the acidic solution to contact the substrate for at least about 10 minutes; scrubbing the substrate after the residency time; applying a treatment solution to the substrate wherein the treatment solution comprises sodium sesquicarbonate-based solution and water with a conductivity less than about 10 micromhos; applying an aqueous rinsing solution comprised of water with a conductivity less than about 10 micromhos after applying the treatment solution; and applying the aqueous rinsing solution, following the application of the treatment solution, until the pH of the substrate is about 7.

The invention includes other embodiments within the scope of the claims, and variations of all embodiments. Additional understanding of the invention can be obtained by referencing the detailed description of exemplary embodiments of the invention below.

### DETAILED DESCRIPTION OF EXEMPLARY EMBODIMENTS

One embodiment of the present invention is a method of preparing a substrate for coating, wherein the substrate is a metallic or concrete material. Examples of metallic or concrete structures include tank farms, oil tanks, oil and gas pipelines, railroad cars and material carriers, general industry piping for fertilizer manufacturers and suppliers, chemical manufacturers and suppliers, and refineries, marine applications, medical devices, and manufacturing equipment. Indeed, any suitable metallic or concrete substrate can be used.

The method of preparing a substrate includes the step of applying an acidic solution to the substrate. Another step comprises applying a treatment solution to the substrate following the application of the acidic solution. A final step comprises, applying an aqueous rinsing solution to the substrate to prepare the substrate for coating. This method cleans the substrate to an atomic or ionic level.

The acidic solution is added to change the oxide state without altering the state of the substrate contaminants. In this embodiment, the acidic solution comprises a citric acid in an aqueous solution, such as water, brine, saltwater, water having a conductivity of less than 10 microohms, or a mixture thereof. The acidic solution can also comprise a gelling agent, such as methyl cellulose. The gelling agent thickens the acidic solution to allow the acidic solution to adhere to the substrate.

In exemplary embodiments, the acidic solution is allowed to maintain a residence time, i.e., stay in contact with the substrate, of at least ten minutes.

In one exemplary embodiment the acidic solution comprises citric acid within a range of about 15 to about 25 weight percent, a gelling agent within a range of about 1.0 to about 3.0 weight percent, and water within a range of about 72 to about 84 weight percent. The citric acid can be anhydrous citric acid which is readily available and environmentally benign.

The treatment solution is applied to decontaminate the surface of the substrate. The treatment solution also breaks down the visible and non-visible layers of oxide (rust) film on the substrate, thereby bringing it to a condition in preparation for decontamination. The treatment solution is applied directly over the acidic solution and can remain on the substrate until visible reaction of bubbling is no longer observed. The treatment solution comprises a carbonate in an aqueous solution, such as water, brine, saltwater, water having a conductivity of less than 10 micromhos, or a mixture thereof.

In one exemplary embodiment, a treatment solution comprising a carbonate in an amount within the range of about 4 to about 10 weight percent. According to another exemplary embodiment, the carbonate is present in an amount of about 8 weight percent. In exemplary embodiments, the carbonate is sodium bicarbonate, sodium sesquicarbonate, or a mixture thereof. Sodium sesquicarbonate is considered advantageous because it is more soluble and has a higher pH than sodium bicarbonate which causes it to be more chemically reactive and work relatively faster. The carbonates are not volatile organic compounds and are environmentally benign.

An aqueous rinsing step is applied to the substrate following the treatment solution until all of the acidic solution and the treatment solution are gone and the pH of the substrate is approximately 7. The aqueous rinsing solution is performed to remove neutralized ionic contaminants and other interference materials, such as impacted abrasive particles, and oil from the substrate. The aqueous rinsing solution can be water, brine, saltwater, water having a conductivity of less than 10 micromhos, or a mixture thereof. The pH can be measured by any known method, such as with pH paper, a machine, a probe and meter, or with a surface membrane electrode.

After the aqueous rinsing solution is applied, the pH of the substrate is about 7, and the treated substrate is dry a standard anti-corrosion coating may be applied.

In an alternative embodiment, the step of cleaning the substrate and the step of rinsing the substrate after the step of cleaning may be performed prior to applying the acidic solution. The step of cleaning the substrate comprises cleaning the substrate to a predetermined standard. The predetermined standard is a visual standard, such as those specified by the National Association of Corrosion Engineers (NACE) or The Society for Protective Coatings (SSPC). These standards of cleanliness, referred to as blasts, result in a surface that when viewed without magnification appears to be free of all visible oil, grease, dust, dirt, mill scale, rust, coating, oxides, paint, corrosion products and other foreign matter. The predetermined standard can be achieved using any suitable method known in the art. One suitable method to achieve the visible standard is to use various abrasive materials, such as sand, coal slag, nickel slag, under pressure and blast the substrate until the predetermined standard is achieved.

The above mentioned step of rinsing the substrate surface after the step of cleaning can then be applied and allowed to dry. This will cause a forced flash rusting and provide a visual comparative of the substrate to be treated. The fluid used in the step of rinsing the substrate can be water, brine, saltwater, water having a conductivity of less than 10 microohms, or a mixture thereof.

In yet another embodiment, a step of scrubbing the substrate after applying the acidic solution and allowing the acidic solution to set on the substrate for a specific amount of time can be implemented into the method. The step of scrubbing the substrate enhances, or speeds up, the breaking of oxide layers present on the substrate. The scrubbing can be performed with any suitable device, such as a rag, cloth, brush, sand paper, stiff bristle brush, or a file.

Another exemplary embodiment provides that the steps of applying the acidic solution to the substrate, optionally scrubbing the substrate, and applying the treatment solution after the step of applying the aqueous rinsing solution may be performed to ensure a decontaminated substrate for coating.

Another exemplary embodiment is a method of providing a service wherein a service provider is contracted to conduct a substrate cleaning in preparation for an application of a new coating. The service provider is an entity that can perform the steps of preparing a substrate for coating as described in the various exemplary embodiments above.

The method of cleaning a substrate in preparation for an anti-corrosion coating is believed to be particularly advantageous for capital intensive industries, such as the oil and gas industry, which currently uses the older, less efficient method described in the background. It is believed that the above disclosed method would reduce costs associated with ongoing anti-corrosion maintenance and repair in terms of material and labor costs, including the premature replacement of infrastructure and subsequent downtime.

Changes may be made in the steps or the sequence of steps of the methods described herein without departing from the spirit and scope of the present invention. Other features and advantages of the present invention are apparent from the detailed description when read in conjunction with the following claims.

What is claimed is:

1. A method of cleaning a substrate, comprising the steps of:
applying an aqueous gel to a substrate;
applying an alkaline aqueous solution to the substrate; and
applying an aqueous rinsing solution to the substrate.

2. The method of claim 1, wherein the acidic aqueous gel further comprises a citric acid.

3. The method of claim 2, wherein the alkaline aqueous gel includes a carbonate.

4. The method of claim 2, wherein at least one of the aqueous solutions comprise water with a conductivity less than about 10 microohms.

5. The method of claim 3, wherein the carbonate is selected from the group consisting of sodium bicarbonate, sodium sesquicarbonate, and combinations thereof.

6. The method of claim 3, wherein the carbonate is sodium sesquicarbonate.

7. The method of claim 1, wherein the aqueous rinsing solution comprises water with a conductivity less than about 10 microohms and is applied until the substrate surface has a pH of about 7.

8. The method of claim 1, further comprising the step of cleaning the substrate to a predetermined standard prior to applying the acidic solution.

9. The method of claim 8, further comprising the step of rinsing the substrate with an aqueous solution prior to applying the acidic aqueous gel.

10. The method of claim 9, wherein the aqueous rinsing solution comprises water with a conductivity less than about 10 microohms.

11. The method of claim 1, further comprising the step of scrubbing the substrate after the step of applying the acidic aqueous gel.

12. The method of claim 11, wherein the step of applying an acidic aqueous gel includes allowing the acidic aqueous gel to contact the substrate for at least about 10 minutes.

13. The method of claim 1, wherein the substrate comprises a metallic or cementitious material.

14. A method of ionically cleaning a substrate, comprising:
applying a rinsing solution comprising water having a conductivity less than about 10 microohms to the substrate;
applying an acidic solution to the substrate wherein the acidic solution comprises anhydrous citric acid, methyl cellulose, and water with a conductivity less than about 10 microohms;
allowing the acidic solution to contact the substrate for at least about 10 minutes;
scrubbing the substrate after the acidic solution has contacted the substrate for at least about 10 minutes;
applying a treatment solution to the substrate wherein the treatment solution comprises sodium sesquicarbonate and water with a conductivity less than about 10 microohms;
applying an aqueous rinsing solution comprised of water with a conductivity less than about 10 microohms after applying the treatment solution; and
applying the aqueous rinsing solution, following the application of the treatment solution, until the pH of the substrate surface is about 7.
